(19) United States
(12) Patent Application Publication
(10) Pub. No.: US 2025/0026183 A1
(43) Pub. Date: Jan. 23, 2025

(54) METHOD FOR DETECTING A FUNCTIONAL STATE OF AN IONIZER IN AN AIR FILTERING SYSTEM

(71) Applicant: MAHLE INTERNATIONAL GMBH, Stuttgart (DE)

(72) Inventors: Sven PETZNER, Welzheim (DE); Daniel EBERLE, Ludwigsburg (DE)

(21) Appl. No.: 18/773,786

(22) Filed: Jul. 16, 2024

(30) Foreign Application Priority Data
Jul. 18, 2023 (DE) 102023206803.6

(51) Int. Cl. B60H 3/06; G01N 15/075

(52) U.S. Cl. CPC B60H 3/0608; G01N 15/075; B60H 2003/0683

(57) ABSTRACT

A method for detecting a functional state of an ionizer in an air filtering system is provided, in particular for a motor vehicle, in which
a measurement apparatus determines the amperage at a discharge electrode in the ionizer at an initial point in time t₀, and sends this to a computer,
the measurement apparatus measures at least one other parameter at the time t₀ and sends this to the computer,
the measurement apparatus measures the amperage at the discharge electrode and the at least one other parameter at a subsequent time t₁ and sends the results to the computer,
the computer obtains at least one comparison value from the measurement values detected by the measurement apparatus at the initial time t₀ and the subsequent time t₁ and compares this with a reference value,
the computer generates a signal and/or takes appropriate measures if the comparison value differs from the reference value by a predefined value.

A lasting filtering effect is obtained therewith, even with worn filters.

### CROSS-REFERENCE TO RELATED APPLICATIONS

This application claims priority from German Patent Application No. DE 102023206803.6, filed Jul. 18, 2023, the entirety of which is hereby incorporated by reference herein.

The present invention relates to a method for detecting the functional state of an ionizer in an air filtering system. The invention also relates to an air filtering system, in particular for a motor vehicle. The invention further relates to an air conditioner for a motor vehicle that contains such an air filtering system, and a motor vehicle with such an air conditioner.

For a pleasant and healthy air quality, the air in a passenger compartment, and/or that supplied to the passenger compartment, should be free of harmful substances (e.g. particulates), noxious gases (e.g. hydrocarbons, nitrogen oxides), and unpleasant odors (e.g. ammonia, trimethylamine, hydrogen sulfide, etc.). Particulate matter pollution is a major problem, in particular in urban areas. The daily mean for this in some cities is often higher than the PM2.5 daily mean of 15 μg/m³ stipulated by the WHO. The removal of dust entering the vehicle interior through the air conditioner is currently achieved with a fiber filter.

The installation space available for these filters in current air conditioners is usually quite small. For this reason, they must have a low flow resistance/pressure loss to be able to still transport the air flow into the vehicle interior, thus satisfying safety requirements such as the prevention of condensation on the windshield. The disadvantage therewith is that the fiber layer in the filter with which the particles are filtered out normally has large pores, such that the level of mechanical dust removal for the filter is usually quite low. Many filter manufacturers ensure that the filters are electrostatically charged during the production process for this reason. The frequently electrostatically charged particles are removed in this manner. Even very small particles of less than 0.3 μm can be removed with this approach without increasing the flow resistance/pressure loss. This electrostatic charge diminishes over time, however, such that the filter becomes less effective as it accumulates dust. The electrostatic charging of the filter therefore only functions well at the start of its service life. This loss of electrostatic charge can already take place after a few weeks or months of use, depending on how polluted the air is.

Particles can also be electrostatically charged with ionizers. These charge the particles in the air upstream of the filter. Moreover, the ions added to the air can also recharge the filter so some extent. The combination results in an increase the in the filtering effect in addition to the purely mechanical filtering by the particle filter by maintaining the electrostatic removal longer. The ionizers that are used often contain a negative discharge electrode, or generate a corona discharge, with which particles are charged. With a negative corona discharge, electrons arise on discharge electrodes shaped like very sharp spikes, and are strongly accelerated near them. The electrons then collide with gas molecules, which consequently lose another electron and become positively ionized. This results in a positive gas molecule and two electrons. This mainly occurs with very high field strengths near the discharge electrodes. At greater distances to the discharge electrodes, the quickly moving electrons tend to accumulate on gas molecules, thus forming negative gas ions. With a negative corona discharge, more gas ions are formed than with a positive corona discharge, because they move more quickly due to their smaller size. This helps in charging the particles, and thus the removal thereof in the downstream filter.

As stated above, the electrostatic charge of the filter diminishes overtime, because the layer of dust on the filter also reduces the electrostatic charge thereof. In this case, charging the particles in the air does not increase the filtering effect. The filtering effect of the ionizers currently in use thus diminishes substantially over time. This can be attributed to not only the decrease in the electrostatic charge, but also to the wear and contamination of the discharge electrodes.

The discharge electrodes in the ionizers are made of very sharp stainless steel spikes or needles. The ion generation results in extremely high temperatures at the tips, dulling them over time. This takes place due to the mechanical wear and/or chemical reactions, in particular where very high temperatures occur, i.e. at the tips. Moreover, the spikes can also become dirty, e.g. with the particles. This reduces the field strengths at the tips, such that fewer ions are generated. The ionizer thus becomes less effective over time. There is currently no means of detecting how well the ionizer still functions, such that it is impossible to know when an ionizer or discharge electrode needs to be replaced, or other countermeasures need to be taken.

The object of the present invention is to therefore create a method for detecting the functional state of an ionizer in an air filtering system.

This problem is solved by the invention with the subject matter of the independent claim 1. Advantageous embodiments are the subject matter of the dependent claims.

The present invention is based on the general idea of first monitoring the wear to a discharge electrode in an ionizer for an air filtering system, and thus maintain the functioning and filtering effect longer. With the method according to the invention for detecting the functional state of an ionizer in an air filtering system, e.g. in an air conditioner for a motor vehicle, amperage at a discharge electrode is first measured at an initial point in time t₀, in particular at the tip of the discharge electrode in the ionizer, and sent to a computer. The measurement apparatus also measures at least one other parameter at that time t₀, which is also sent to the computer. The time t₀ is the starting time, i.e. when the air conditioner or ionizer is first put to use. The amperage at the discharge electrode is subsequently measured at a later time t₁, in particular at its tip, as well as the at least one other parameter, and these results are also sent to the computer. The subsequent time t₁ can be at any time after the initial time t₀. The computer then determines at least one comparison value from the measurements at the initial time t₀ and the subsequent time t₁, and compares this value with a reference value, in particular a reference value stored in a table. This is necessary because the measured amperage is affected by not only a dulling of the tip of the discharge electrode over time, but also by other parameters, e.g. particle concentration. To therefore examine and assess the wear to the tip of the discharge electrode in isolation, the other parameters affecting the amperage must be deducted. The computer subsequently generates a signal and/or takes appropriate measures if the comparison value differs from the reference value by a predefined value. The computer can generate a replacement signal indicating that the discharge electrode or ionizer needs to be replaced. The computer could also take an appropriate measure, e.g. increasing the voltage at the discharge electrode in the ionizer when the comparison value differs from the reference value by a predefined value. The predefined value indicates significant wear to the tip of the discharge electrode, rendering it no longer functional, at which reliable and sufficient generation of ions, and therefore reliable and sufficient air filtering, can no longer be ensured. The method according to the invention results in a comparatively simple means of monitoring the functional state of an ionizer in an air filtering system, and makes it possible to take appropriate measures when the discharge electrodes wear out. The method according to the invention eliminates the need to replace the at least one discharge electrode on a regular basis, and instead it can be used until the wear thereto has reached a predefined extent detected by the method according to the invention. The method according to the invention also prevents the ionizer, and therefore the air filtering system, from no longer functioning correctly when the wear within a normal cycle is extraordinarily high, such that the discharge electrode has already become worn and can no longer generate sufficient ions, before this cycle has ended. The method according to the invention ensures that the ionizer is able to constantly generate as many ions as possible over the entire service life of the ionizer. Only replacing the ionizer, or the at least one discharge electrode, when needed, conserves resources and reduces costs. When the ionizer continuously functions properly because it has been monitored using the method according to the invention, substantially fewer particles are able enter the passenger compartment of a motor vehicle, due to a significantly better air filtering. The method according to the invention also constantly informs the user of the extent of wear to the ionizer, or its at least one discharge electrode, similarly to monitoring how full the bag in a vacuum cleaner is, thus informing the user early enough when the at least one discharge electrode needs to be replaced. The computer can also increase the voltage to the at least one discharge electrode, resulting in an increase in ion generation.

In another advantageous embodiment of the method according to the invention, the measurement apparatus detects the amount of air flowing around the discharge electrode, or its tip, and sends this to the computer, which is then taken into account in computing the comparison value. The measurement apparatus can detect the volumetric flow with an air volume sensor, which can also affect the amperage at the discharge electrode, but has nothing to do with the actual wear to the discharge electrode. Measurements of the air volume can be estimated by the setting of the vehicle air conditioner, for example. The air volume can also be estimated based on the power consumption of the vehicle air conditioner.

In another advantageous embodiment of the method according to the invention, the measurement apparatus detects the particle concentration flowing around the discharge electrode, or its tip, and also sends this to the computer. A particle sensor can be used for this, in particular a PM2.5 sensor. This particle sensor can use lasers for measuring dust concentrations in realtime. The amount of ions needed for the desired air quality, and therefore the voltage to be applied to the discharge electrode, can be determined by the particle concentration. A higher particle concentration in the air flowing around the discharge electrode, or its tip, requires a higher ion concentration for a sufficient bonding to these particles. The particle concentration also affects the amperage at the discharge electrode detected by the measurement apparatus, although this has nothing to do with the actual wear to the discharge electrode, and must therefore be isolated to obtain accurate results.

In another advantageous embodiment of the method according to the invention, the measurement apparatus measures at least one of the following: the ambient temperature, humidity, and/or gaseous contamination at the discharge electrode or its tip, and sends this to the computer as a further parameter. These also affect the amperage measured at the discharge electrode, even though they have nothing to do with the wear to the tip of the discharge electrode. Higher temperatures indicate higher mobility of the gas ions, and higher current in the typical temperature range for the HVAC. An increase in humidity reduces the current in the typical temperature range for the HVAC. Gaseous contamination affects the performance of the ionizer.

In a particularly preferred embodiment of the method according to the invention, the computer generates a signal for replacing the at least one discharge electrode, or its tip, when the comparison value differs from the reference value by a predefined value. If the computer determines that the tip has become dull and is therefore less effective and the comparison value differs from the reference value by the predefined value, e.g. via a current or voltage drop at a shunt resistor, the computer indicates to a user that the discharge electrode, or its tip, or the entire ionizer, needs to be replaced. Consequently, the discharge electrode, the tip, and/or the ionizer only needs to be replaced if it has actually worn out to the extent that it can no longer generate the ions necessary for the air quality that is required. Premature replacement, e.g. at a regular interval, is prevented, thus conserving resources and reducing costs.

With a particularly preferred embodiment of the method according to the invention, the computer adjusts an input voltage to the discharge electrode in the ionizer, in particular increasing it, if the comparison value differs from the reference value by a predefined value. If, for example, the amperage, and therefore the voltage, at a shunt resistor attached to the discharge electrode falls to the extent that it can be concluded that the discharge electrode, and therefore the ionizer, no longer functions properly, the input voltage can be increased, such that the discharge electrode generates more ions again, and the functioning of the air filtering system can be maintained.

In another advantageous embodiment of the method according to the invention, the measurement apparatus measures the amperage at a shunt resistor for the discharge electrode. This shunt resistor allows for an indirect measurement of a voltage drop through the change in amperage, because the resistance remains constant, unlike that of the tip when it becomes dull. This shunt resistor therefore results in a structurally simple, nevertheless effective and inexpensive measurement of the change in amperage and therefore the change in voltage at the discharge electrode.

The present invention is also based on the general concept of creating an air filtering system that has an ionizer with at least one discharge electrode, in which the air filtering system also has a measurement apparatus for detecting the amperage at the discharge electrode in the ionizer and a further parameter, and in which the measurement apparatus is also designed to send the amperage and the at least one other parameter to a computer. The computer, which is also, or can be, part of the air filtering system, is configured such that the measurement values obtained at times t₀ and t₁ are converted to a comparison value and compared with a reference value. The computer subsequently generates a signal and/or takes appropriate measures when the comparison values differ from the reference value by at least a predefined value. The at least one other parameter at times t₀ and t₁ is also incorporated in determining the comparison value. The air filtering system according to the invention makes it possible for the first time to obtain a greatest possible and constant ionization over the entire service life of the ionizer or air filtering system. If it is no longer possible to increase the voltage to the discharge electrode, for example, the computer can generate a signal indicating the need to replace the discharge electrode or ionizer, such that these are only replaced when it is actually necessary for maintaining the functionality thereof. This results in significant savings compared to regular replacement of the ionizer, in which the discharge electrode or ionizer are replaced when it is not necessary. The air filtering system according to the invention results in significantly better air filtering and therefore significantly better air quality, which has a positive effect on the impressions of the passengers.

The present invention is also based on the general concept of equipping an air conditioner in a motor vehicle with the air filtering system described above, and thus obtaining the same advantages for the air conditioner, or a motor vehicle equipped with such an air conditioner.

The specification can be readily understood with reference to the following Representative Paragraphs:

Representative Paragraph 1. A method for detecting a functional state of an ionizer in an air filtering system, in particular for a motor vehicle, in which
a measurement apparatus determines the amperage at a discharge electrode in the ionizer at an initial point in time t₀, and sends this to a computer,
the measurement apparatus measures at least one other parameter at the time t₀ and sends this to the computer,
the measurement apparatus measures the amperage at the discharge electrode and the at least one other parameter at a subsequent time t₁ and sends the results to the computer,
the computer obtains at least one comparison value from the measurement values detected by the measurement apparatus at the initial time t₀ and the subsequent time t₁ and compares this with a reference value,
the computer generates a signal and/or takes appropriate measures if the comparison value differs from the reference value by a predefined value.

Representative Paragraph 2. The method according to Representative Paragraph 1, characterized in that the measurement apparatus detects the amount of air flowing around the discharge electrode or the tip thereof, and sends this to the computer.

Representative Paragraph 3. The method according to Representative Paragraph 1 or 2, characterized in that the measurement apparatus detects a particle concentration flowing around the discharge electrode or the tip thereof, and sends this to the computer.

Representative Paragraph 4. The method according to any of the preceding Representative Paragraphs, characterized in that the measurement apparatus detects at least one of the following as a further parameter: the temperature, humidity, and/or gaseous contamination surrounding the discharge electrode or the tip thereof, and sends this to the computer.

Representative Paragraph 5. The method according to any of the preceding Representative Paragraphs, characterized in that the computer generates a signal for replacing the discharge electrode or the tip thereof, if the comparison value differs from the reference value by the predefined value.

Representative Paragraph 6. The method according to any of the preceding Representative Paragraphs, characterized in that the computer adjusts the input voltage to the discharge electrode in the ionizer, if the comparison value differs from the reference value by a predefined value.

Representative Paragraph 7. The method according to any of the preceding Representative Paragraphs, characterized in that the measurement apparatus measures the amperage at a shunt resistor on the discharge electrode in the ionizer.

Representative Paragraph 8. An air filtering system that has
an ionizer with a discharge electrode,
a measurement apparatus for detecting the amperage at the discharge electrode in the ionizer and at least one other parameter, which are then sent to a computer,
a computer configured to execute the method according to any of the preceding Representative Paragraphs, i.e. to determine at least one comparison value from the measurement values obtained with the measurement apparatus at the times t₀ and t₁, and compares this with a reference value, and generates a signal and/or takes an appropriate measure, if the comparison value differs from the reference value by at least one predefined value

Representative Paragraph 9. The air filtering system according to Representative Paragraph 8, characterized in that the measurement apparatus contains at least one of the following sensors: an air quantity sensor, a particle sensor, a temperature sensor, a humidity sensor, and/or a sensor for detecting gaseous contamination.

Representative Paragraph 10. An air conditioner for a motor vehicle that has an air filtering system according to either of the Representative Paragraphs 8 or 9.

Representative Paragraph 11. A motor vehicle that has an air conditioner according to Representative Paragraph 10.

1. A method for detecting a functional state of an ionizer in an air filtering system, in particular for a motor vehicle, comprising
a measurement apparatus determines an amperage at a discharge electrode in the ionizer at an initial point in time t₀, and sends this to a computer,
the measurement apparatus measures at least one other parameter at the time t₀ and sends the measured at least one other parameter at the time t₀ to the computer,
the measurement apparatus measures an amperage at the discharge electrode and the at least one other parameter at a subsequent time t₁ and sends the measured amperage at the subsequent time t₁ to the computer,
the computer obtains at least one comparison value from the measurement values detected by the measurement apparatus at the initial time t₀ and the subsequent time t₁ and compares the at least one comparison value with a reference value,
the computer generates a signal and/or takes appropriate measures if the comparison value differs from the reference value by a predefined value.

2. The method according to claim 1, wherein the measurement apparatus detects the amount of air flowing around the discharge electrode or the tip thereof, and sends the measured amount of air flowing to the computer.

3. The method according to claim 1, wherein the measurement apparatus detects a particle concentration flowing around the discharge electrode or the tip thereof, and sends the detected particle concentration flowing to the computer.

4. The method according to claim 1, wherein the measurement apparatus detects at least one of the following as a further parameter: the temperature, humidity, and/or gaseous contamination surrounding the discharge electrode or the tip thereof, and sends the at least one detected parameter to the computer.

5. The method according to claim 1, wherein the computer generates a signal for replacing the discharge electrode or the tip thereof, if the comparison value differs from the reference value by the predefined value.

6. The method according to claim 1, wherein the computer adjusts the input voltage to the discharge electrode in the ionizer, if the comparison value differs from the reference value by a predefined value.

7. The method according to claim 1, wherein the measurement apparatus measures the amperage at a shunt resistor on the discharge electrode in the ionizer.

8. An air filtering system, comprising:
an ionizer with a discharge electrode,
a measurement apparatus configured to detect the amperage at the discharge electrode in the ionizer and at least one other parameter, which are then sent to a computer,
a computer configured to execute the method according to claim 1, i.e. to determine at least one comparison value from the measurement values obtained with the measurement apparatus at the times t₀ and t₁, and compares this with a reference value, and is configured to generate a signal and/or take an appropriate measure, if the comparison value differs from the reference value by at least one predefined value

9. The air filtering system according to claim 8, wherein the measurement apparatus contains at least one of the following sensors: an air quantity sensor, a particle sensor, a temperature sensor, a humidity sensor, and/or a sensor for detecting gaseous contamination.

10. An air conditioner for a motor vehicle that has an air filtering system according to claim 8.

11. A motor vehicle comprising an air conditioner according to claim 10.
